(19) United States
(12) Patent Application Publication
(10) Pub. No.: US 2018/0115768 A1
(43) Pub. Date: Apr. 26, 2018

(54) SYSTEM AND METHOD FOR GENERATING AND RELEASING STEREOSCOPIC VIDEO FILMS

(71) Applicant: VISUAL VERTIGO SOFTWARE TECHNOLOGIES GMBH, Wien (AT)

(72) Inventor: Alexander KLESZCZ, Bielsko Biala (PL)

(73) Assignee: Visual Vertigo Software Technologies GMBH, Vienna (AT)

(21) Appl. No.: 15/568,916

(22) PCT Filed: Apr. 21, 2016
(86) PCT No.: PCT/EP2016/058836

§ 371 Date: Oct. 24, 2017

(30) Foreign Application Priority Data
Apr. 24, 2015 (EP) 15164966.2

(51) Int. Cl. H04N 5/232; H04N 5/76; H04N 13/00

(52) U.S. Cl. CPC H04N 13/0264; H04N 13/0429; H04N 13/0055; H04N 5/76; H04N 5/23238

(57) ABSTRACT

The invention relates to a system (1) for releasing a stereoscopic video film (2). The system (1) has a data processing unit (3), which is configured to receive and to process a monoscopic video film (7), and to release the stereoscopic video film (2). The monoscopic video film (7) has been recorded using a video recording device (4) having a one single objective (8).

The system (1) is characterized in that the data processing unit (3) is configured to receive and to evaluate a motion information (14) allocated to the monoscopic video film (7), or to determine the motion information (14) to be allocated to the monoscopic video film (7). The motion information (14) is characterized by a motion direction (27) of the video recording device (4) in regard to a filmed object (11). The data processing unit (3) is configured to generate the stereoscopic video film (2) from two content-identical and temporally delayed monoscopic video films.

The invention relates to a system for releasing a stereoscopic video film, wherein the system has a data processing unit, which is configured to receive and to process a monoscopic video film and to release the stereoscopic video film, wherein the monoscopic video film has been recorded using a video recording device having only a single objective.

The invention further relates to a method for generating and replaying a stereoscopic video film from a monoscopic video film recorded using a video recording device having only a single objective.

According to prior art, the focus of the state-of-the-art display technology used, e.g., with TV sets, computer screens or portable smart phones or tablet computers, is placed on the two-dimensional or monoscopic presentation. Human vision, however, is based on spatial or stereoscopic vision. In order to replay stereoscopic images, there is made use of stereovision, this is image pairs having depth impression, which are composed of respectively one image for each of the two eyes, and of motion parallax, which enables the presentation of the position of various objects in space by means of image sequences of a moving viewer. Stereoscopic images or video films, hence, are composed of two two-dimensional images, respectively one for each of the two eyes of the viewer. The human brain receives these two different images, generating the spatial structure of the image or the video film therefrom.

The document US 2008/0080852 A1 discloses a system and a method for generating stereoscopic images. The system therein uses a camera in order to produce several multi-focus recordings of an object and to generate a stereoscopic image therefrom. In this way, by means of a data processing unit and a complex algorithm, there is calculated a combined depth impression from the multi-focus recordings. From the depth impressions of various recordings, there is identified, by means of a further complex algorithm, a single-focus image. By means of the so-called “depth-based rendering”, there is finally generated a stereoscopic image, which is composed of an image for the left eye and an image for the right eye of the viewer, which may be displayed via a stereoscopic display unit.

In the known system, it has proven to be disadvantageous that there are required several multi-focus recordings of an object for the generation of each individual stereoscopic image. This strains the data processing unit as well as a possibly required non-volatile storage likewise. In the case of a data transfer in real time, the very large amount of data may also lead to transfer problems. As there are performed several complex algorithms for the generation of a stereoscopic image, the requirements in regard to the performance of the data processing unit are very high. As the time required for the generation of the stereoscopic image is essentially determined by the time of data transfer as well as the performance and calculation of the algorithms, this may be too long for a practical application.

In addition, it has proven to be disadvantageous that the method described in the preceding paragraph has to be performed for every individual frame of the video film in order to generate a stereoscopic video film. This will inevitably lead to even bigger drawbacks in regard to the performance of the data processing unit as well as for the time required for the generation of the stereoscopic video.

The invention is based on the task to provide a system and an associated method for generating and releasing stereoscopic video films, in which the preceding disadvantages will not occur and in which the requirements in regard to the performance of the data processing unit as well as the time required for the generation of the stereoscopic video will be significantly reduced.

According to the invention, this task is solved in a system in that the data processing unit is configured to receive and evaluate a motion information allocated to the monoscopic video film or to determine the motion information to be allocated to the monoscopic video film, which motion information characterizes a motion direction of the video recording device in regard to a filmed object, wherein the data processing unit is configured to generate the stereoscopic video film from two content-identical and temporally delayed monoscopic video films.

According to the invention, this task is solved in a method in that the following process steps are carried out:
A) receiving the monoscopic video film and optionally a motion information allocated to the monoscopic video film;
B) evaluating or determining the motion information allocated to the monoscopic video film, which characterizes a motion direction of the video recording device in regard to a filmed object;
C) processing two content-identical monoscopic video films of the stereoscopic video film to be released from the monoscopic video film;
D) delaying one of the two monoscopic video films of the stereoscopic video film to be released;
E) releasing the stereoscopic video film generated in the process steps A)-D) to a stereoscopic display unit.

In this way, there is obtained the advantage that the stereoscopic video film may be generated directly from the monoscopic video film, which has been recorded using the video recording device having only a single objective. For this purpose, there is not required a technically complex and cost-intensive stereoscopic recording device. The associated method for processing the stereoscopic video film from the monoscopic video film and releasing it requires, in comparison to the prior art described above, no lengthy and complicated algorithms that are to be performed by the data processing unit.

Similarly, the system according to the invention does not require multiple multi-focus recordings or depth impressions of multiple recordings. These advantages will reduce the data amount produced, the required evaluation time as well as the pertaining development time and costs for the stereoscopic video film.

The system in an embodiment according to the invention requires exclusively the image information of the monoscopic video film in order to generate and release the stereoscopic video film from the monoscopic video film. From this, it may then determine the motion information allocated to the monoscopic video film, which is composed of the motion direction of the video recording device in regard to the filmed object.

In an advantageous embodiment, already after having received the data, the system has been provided with the motion information allocated to the monoscopic video film, and the data processing unit only has to evaluate this motion information.

From the monoscopic video film and the motion information allocated, the data processing unit may now generate two content-identical but temporally delayed monoscopic video films. These will be released side-by-side as the stereoscopic video film.

In order to evaluate the motion information, the data processing unit differentiates between a first motion component of the video recording device, in the direction of the optical axis of the single objective, and a second motion component of the video recording device, transversely to the direction of the optical axis of the single objective. If during a sequence of at least two successive frames of the recorded monoscopic video film exclusively the first motion component is available, this frame of the stereoscopic video film will be identified according to a first processing. If, however, during a sequence of at least two successive frames the second motion component is available, this frame of the stereoscopic video film will be identified according to a second processing.

The two different processings are advantageous insofar as they enable the system to determine, at any point of time of the motion and in every motion direction of the video recording device, a stereoscopic effect and, hence, also the stereoscopic video film.

In this way, the data processing unit in the first processing utilizes only the left half or only the right half of the frames of the monoscopic video film for processing the stereoscopic video film. For example, if the left half of the frames has been selected, each frame of the monoscopic video film is cut to the size of the left half thereof. This size-cut monoscopic video film will then be copied, and the two content-identical films will be released side-by-side, respectively for the left eye and the right eye of the viewer, as a stereoscopic video film. In order to make possible the stereoscopic effect, the monoscopic video film of the stereoscopic video film associated with the left eye of the viewer will be delayed by a determined amount of frames per second, and the monoscopic video film of the stereoscopic video film associated with the right eye of the viewer will be released without delay.

In the second processing, the data processing unit may utilize the entire, this is uncut, frames, or it may utilize only the left or the right half of the frames according to the first processing. The second motion component hereby available, hence, corresponds to a relative motion of the video recording device towards the film object from the left to the right, for example. In order to make possible the stereoscopic effect, in the present example the monoscopic video film of the stereoscopic video film associated with the left eye of the viewer will then be delayed by a determined amount of frames per second, and the monoscopic video film of the stereoscopic video film associated with the right eye of the viewer will be released without any delay.

In an advantageous embodiment the data processing unit will utilize, as soon as during a sequence of at least two successive frames within the recorded monoscopic video film the first motion component is available, also in the second processing always only the left half or only the right half of all frames of the monoscopic video film. This has the advantage that when viewing the stereoscopic video film no sudden adaptation of the video formats within the stereoscopic display unit has to be performed, which would be disturbing for the viewer.

Thereby, the data processing unit need not select exactly the left half or exactly the right half of the frames of the monoscopic video film. Instead, the data processing unit may, on the availability of the first motion component of the video recording device in the direction of the optical axis of the single objective during a sequence of at least two successive frames, in the first processing and in the second processing select only a left-weighted partial image as the left half or only a right-weighted partial image as the right half of the frames of the monoscopic video film.

In an advantageous embodiment of the system, the motion information allocated to the monoscopic video film comprises, in addition to the motion direction of the video recording device in regard to the filmed object, a motion speed and a recording rate of the video recording device. This has the advantage that by way of this information the data processing unit may determine automatically and in real time, which part of the stereoscopic video film needs to be delayed by which amount, in order to make possible the stereoscopic effect.

In a further advantageous embodiment of the system, a user may manually control which part of the stereoscopic video film is released by the data processing unit delayed by which amount in order to make possible the stereoscopic effect in an individual way.

In an advantageous embodiment of the system, the video recording device has a 3-axis-stabilisator. The 3-axis-stabilisator serves for stabilizing the video recording device during recording of the monoscopic video film. In this way, “blurring” of the recording will be prevented and a stereoscopic effect optimally enabled.

The provision of a non-volatile storage enables storing of the monoscopic video film recorded using the video recording device. This may then be received and evaluated locally and temporally independently by the data processing unit. On the other side, the provision of a data communication unit for the wireless communication will enable that the recorded monoscopic video film, and, preferably, also the appropriately allocated motion information, may be transferred within the frame of the radio range in a locally independent way and in real time.

In an advantageous embodiment of the system, there is provided an autonomous and unmanned transport means, preferably a drone, for recording and for guiding the video recording device. In the concrete case of the drone, this has the 3-axis-stabilisator and a GPS module. In this way, the monoscopic video film recorded by the video recording device may be transferred to the data processing unit in essentially real time.

If the system in addition has a stereoscopic display unit, which is connected to the data processing unit, the stereoscopic video film identified by the data processing unit may be viewed by the viewer essentially in real time.

In an embodiment according to the invention, the stereoscopic display unit is configured as a screen of a TV set or a computer, or as a projector, and has 3D glasses, preferably virtual reality 3D glasses.

In an advantageous embodiment, the data processing unit is part of a mobile telecommunication device, for example a smart phone, or of a mobile tablet computer. In combination with the stereoscopic display unit, which is composed, for example, of a screen of the device and virtual reality 3D glasses, monoscopic video films, which have been recorded using a video recording device having only a single objective, may thus be viewed in real time.

In a further advantageous embodiment of the system, the video recording device is held in a stationary position by the viewer or the transport means, while a monoscopic 360-degrees-video film is being recorded. From the recorded monoscopic 360-degrees-video film, the data processing unit processes a stereoscopic panoramic image, which is composed of two content-identical and temporally delayed monoscopic 360-degrees-video films. This stereoscopic panoramic image may be viewed by the viewer by means of the stereoscopic display unit, which is composed of, for example, a smart phone and passive virtual reality 3D glasses.

In a further advantageous embodiment of the system, the video recording device is configured as a 360-degrees-video recording device. In this way, the 360-degrees-video recording device comprises a single objective, which covers a recording area of 360 degrees transversely to the optical axis of the single objective. The 360-degrees-video recording device comprises preferably several single objectives, preferably each with an image sensor of its own. The data processing unit processes, by way of the monoscopic video films and the allocated motion information of all single objectives, the stereoscopic video film to be released within the recorded 360-degrees-surrounding. In this way, there is processed a smooth transition between the different recording areas of the single objectives so that the viewer wearing passive or active virtual reality 3D glasses may move essentially freely in a stereoscopic virtual surrounding.

Because of the configuration of the video recording device as a 360-degrees-video recording device there is obtained the advantage that, in comparison to known 360-degrees-systems, which record the 360-degrees-surrounding in several individual images, which they later on combine, there will not be necessary such a combination of images, thus no “stitching errors”, i.e. errors at the transition between two combined images, will occur. The method for producing and releasing the stereoscopic video film is thus simplified, and the quality of the released stereoscopic video film is improved.

Further advantageous embodiments of the system according to the invention will be explained in detail by means of the figures.

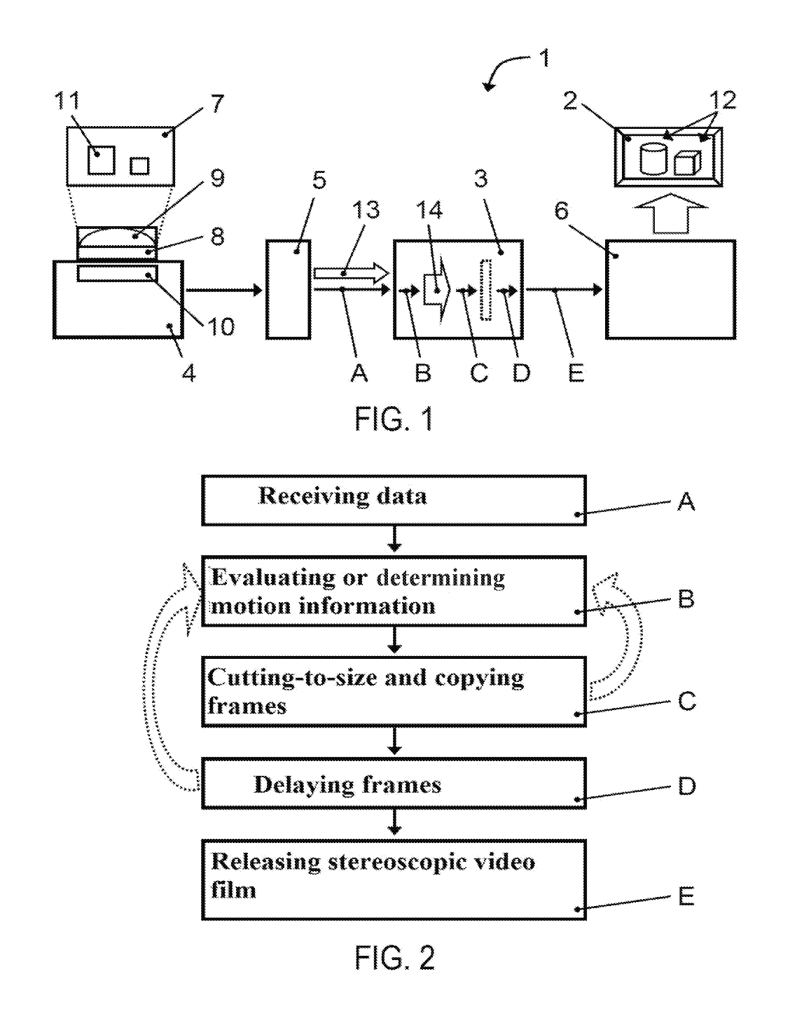

FIG. 1 shows a block diagram of a system for releasing a stereoscopic video film according to a first embodiment of the invention.

FIG. 2 shows a flow chart of a method for releasing a stereoscopic video film according to the invention.

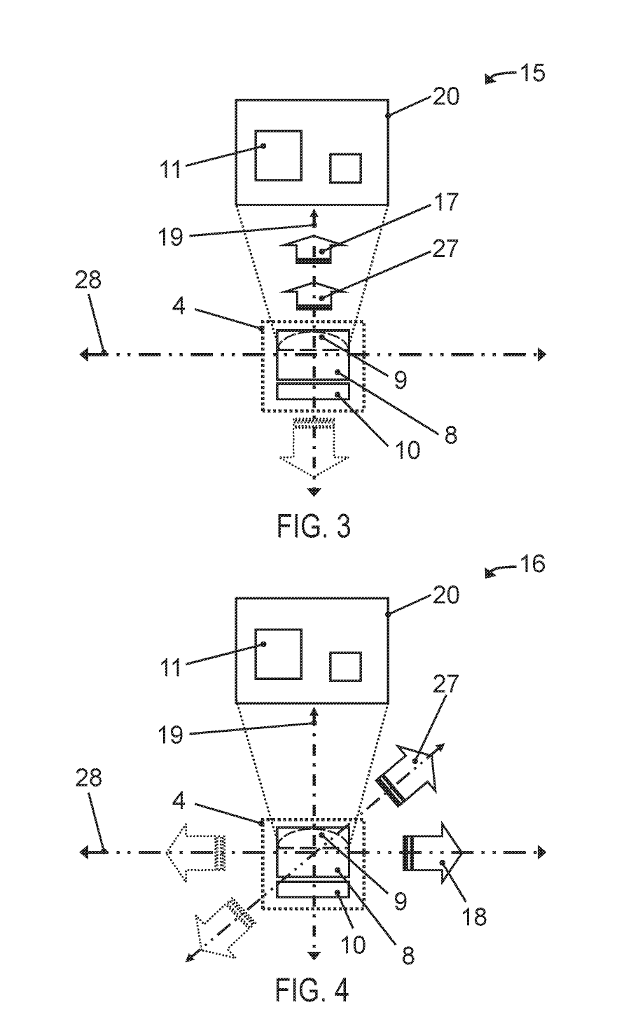

FIG. 3 shows a first motion component of a video recording device according to the invention.

FIG. 4 shows a second motion component of the video recording device according to the invention.

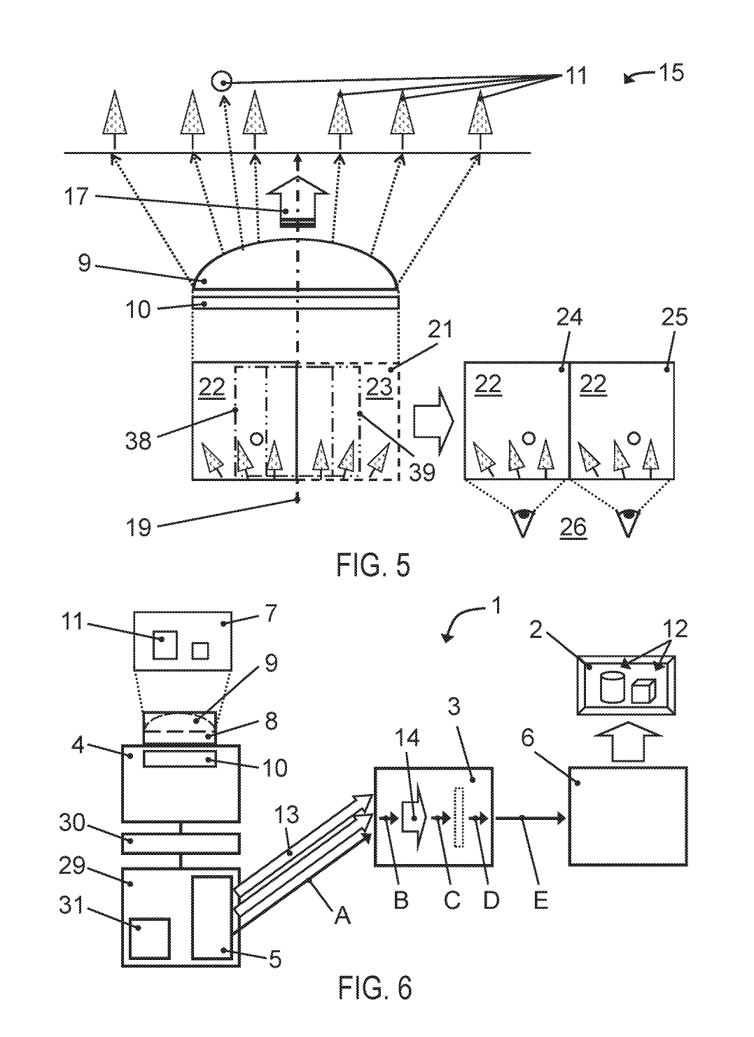

FIG. 5 shows a first processing of the system for releasing the stereoscopic video film.

FIG. 6 shows a block diagram of a system for releasing a stereoscopic video film according to a further embodiment of the invention.

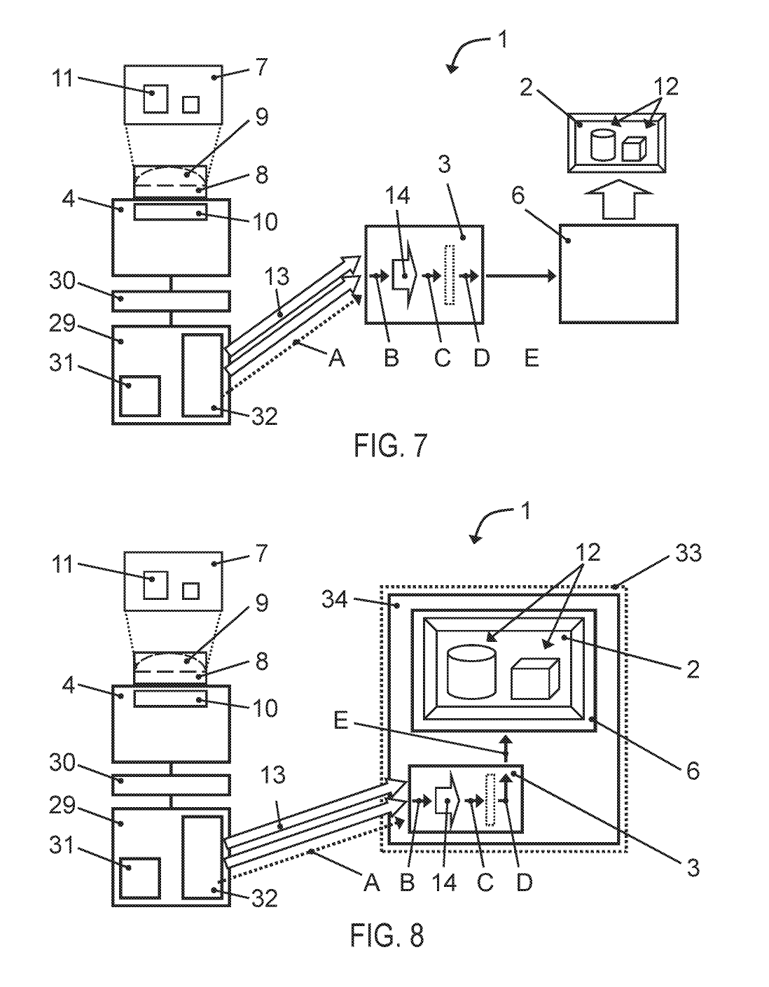

FIG. 7 shows a block diagram of a system for releasing a stereoscopic video film according to a further embodiment of the invention.

FIG. 8 shows a block diagram of a system for releasing a stereoscopic video film according to a further embodiment of the invention.

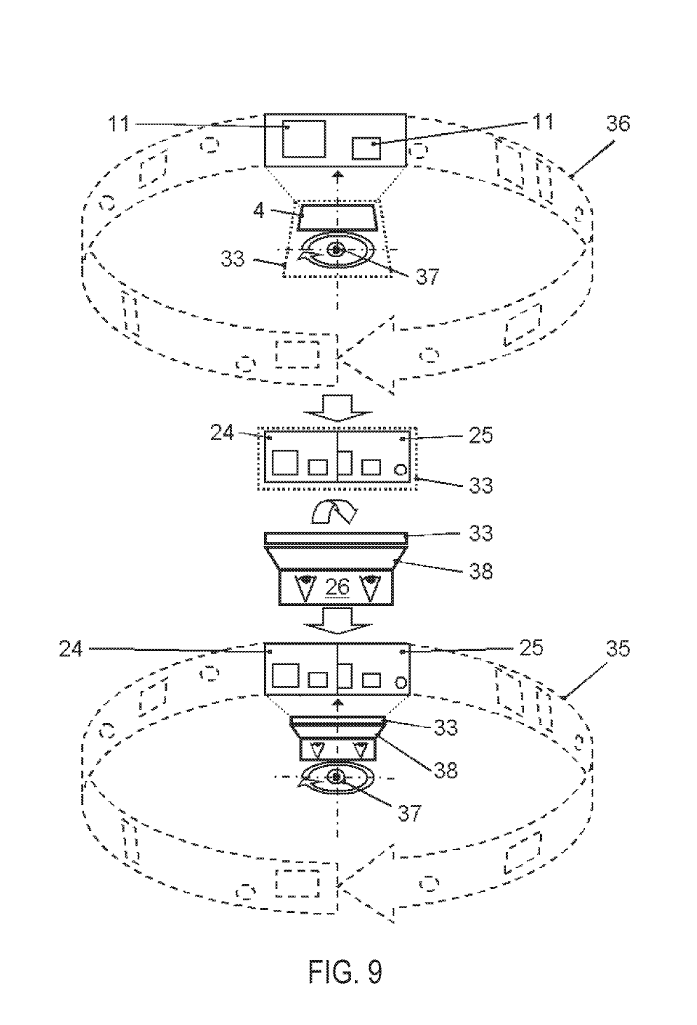

FIG. 9 shows a system for releasing a stereoscopic panoramic image according to a further embodiment of the invention.

FIG. 1 shows a block diagram of a system 1 for releasing a stereoscopic video film 2, wherein the system in the present embodiment comprises a data processing unit 3, a video recording device 4, a non-volatile storage 5 and a stereoscopic display unit 6. Thereby, a monoscopic video film 7 is recorded using the video recording device 4. The video recording device 4 is a digital camera having a single objective 8, an optical lens 9 as well as an image sensor 10. The video recording device 4 records the monoscopic video film 7 by means of the optical lens 9, which is located in the single objective 8, as well as the image sensor 10. If, during a sequence of at least two successive frames 21 of the recorded monoscopic video film 7, the video recording device 4 is in motion in regard to at least one filmed object 11, then the stereoscopic video film 2 may be processed therefrom. If, during a sequence of at least two successive frames 21 of the recorded monoscopic video film 7, the video recording device 4 is not in motion in regard to at least one filmed object 11, then the stereoscopic video film 2 may not be processed, and during this sequence of at least two successive frames 21 of the recorded monoscopic video film 7 the monoscopic vide film 7 is released instead of the stereoscopic video film 2.

At any point of time, the motion of the video recording device 4 should be in a stabilized situation in order to make possible a stereoscopic effect 12 of the stereoscopic video film 2 in an optimal way. Hence, at no point of time the recorded monoscopic video film 7 should be blurred, as then also the stereoscopic video film 2 would be released in a blurred way, thus, reducing a stereoscopic effect 12.

The monoscopic video film 7 is transferred from the video recording device 4 to the non-volatile storage 5, for example, a memory card.

The data processing unit 3, in a process step A, receives an image information 13. Process step A as well as subsequent process steps B to E are illustrated in FIG. 2. From the image information 13 received, the data processing unit 3 in process step B identifies a motion information 14 to be allocated to the monoscopic video film 7. This motion information 14 thus corresponds to a motion direction 27 of the video recording device 4 in regard to the filmed object 11, which is selected as a reference object by a video analysis programme. The video analysis programme labels the reference object using a dot and identifies the temporal change of the motion of this dot. If the reference object, for example, becomes larger, then the video recording device 4 will move towards the reference object, and vice versa. If the dot moves from the right to the left, then the video recording device 4 will move in regard to the reference object from the left to the right, and vice versa.

As a function of the identified motion information 14, the data processing unit 3 performs a first processing 15 and a second processing 16, wherein the first processing 15 is allocated to a first motion component 17 and the second processing 16 is allocated to a second motion component 18. The FIGS. 3 and 4 illustrate these motion directions 18 and 19. The motion direction 27 of the video recording device 4, hence, is always composed of a portion of the first motion component 17 and a portion of the second motion component 18.

The first motion component 17 is schematically illustrated in FIG. 3. Therein, the video recording device 4 moves in the direction of the optical axis of the single objective 8 and the optical lens 9, along a surface normal 19, towards the projected monoscopic image area, in which the filmed object 11 is situated. This projected image area may be considered as being in parallel to an image 20 recorded by the image sensor 10.

If, during a sequence of at least two subsequently recorded images 20 of the motion information 14 allocated to the monoscopic video film 7, exclusively the first motion component 17 is available, then the portion of the second motion component 18 in the motion direction 27 of the video recording device 4 is zero and the data processing unit 3 processes the stereoscopic video film 2 according to the first processing 15.

In the process, the motion direction 27 of the video recording device 4 always relates to the image 20 recorded by the image sensor 10, which has at least one filmed object 11. If actually only one characteristic filmed object 11 is in the recorded image 20, then there has to be available at least one characteristic background in the recorded image 20 in order to process a stereoscopic frame of the stereoscopic video film 2 therefrom. In order to make use of the invention, several filmed objects 11 are advantageous.

A process step C of this first processing 15 is illustrated in FIG. 5. In the first processing 15, the invention utilizes the distortion of the respective recorded image 20. The recorded image 20 corresponds to one individually recorded frame 21 of the monoscopic video film 7, which is composed of a temporal sequence of frames 21. Distortion is caused if the video recording device 4 moves along the first motion component 17 towards several objects to be filmed. Due to the different optical path of the light within the optical lens 9 as well as the optical transitions thereof to ambient air, each filmed object 11 is displayed following its recording at different grades of distortion. The object 11 filmed in the respective frame 21 is displayed more distorted the farther away it is positioned from the central axis of the optical lens 9—on the projected monoscopic image area.

If, during the sequence of at least two successive frames 21 of the monoscopic video film 7, at least one filmed object 11 is moving, then a motion speed of the video recording device 4 is appropriately adjusted in order to prevent double or blurred stereoscopic frames of the stereoscopic video film 2 to be released. The higher the motion speed of the filmed object 11 is, the higher the motion speed of the video recording device 4 has to be.

The data processing unit 3 in process step C selects either a left half 22 or a right half 23 of the recorded frames 21 of the monoscopic video film 7 and cuts these frames 21 to the size of, for example, their left halves 22. In a next step, the left halves 22 of all these frames 21 are copied. These two sequences of content-identical and size-cut frames 21 are successively released side-by-side, respectively for a left eye 24 and a right eye 25 of a viewer 26, with delay, forming the stereoscopic video film 7. In the present example, the two monoscopic video films of the stereoscopic video film 2 to be released are formed by the left halves 22 of the frames 21 of the recorded monoscopic video film 7.

Alternatively, the data processing unit 3 in process step C selects either a left-weighted partial image 38 as the left half 22 or a right-weighted partial image 39 as the right half 23 of the frames 21 of the monoscopic video film 7 and cuts these frames 21 to the size of the, for example, left-weighted partial image 38. In the next step, the left halves 22, formed by the left-weighted partial images 38, of all these frames 21 are copied. These two sequences of content-identical and size-cut frames 21 are released successively side-by-side, respectively for a left eye 24 and a right eye 25 of a viewer 26, temporarily delayed, forming the stereoscopic video film 2.

“Left-weighted” in this case means that more than the half, i.e. at least 50.1 percent, of the area or of the pixels in the selected image cut-out, to which size there is cut, are positioned to the left of the image centre, thus, in FIG. 5 the left-weighted partial image 38 to the left of the surface normal 19. “Right-weighted” in this case means that more than the half, i.e. at least 50.1 per cent, of the area or of the pixels in the selected image cut-out, to which size there is cut, are positioned to the right of the image centre, thus, in FIG. 5 the right-weighted partial image 39 to the right of the surface normal 19. Selecting and size-cutting may also be performed via zooming into the frame 21, i.e. enlarging the frame 21, and shifting the enlarged cut-out towards the left or the right in order to obtain a left-weighted partial image 38 or a right-weighted partial image 39. The choice, whether size-cutting is performed to the left halves 22 or the right halves 23 of all frames 21 of the monoscopic video film 7, may also be made manually by the viewer 26.

In a process step D, which is not depicted in FIG. 5, the data processing unit 3 determines a delay of the monoscopic video film 7 for the left eye 24 or the right eye 25 of the viewer 26 by a determined amount of frames per second. Which monoscopic video film will be delayed, depends in the first processing 15 on which halves of the frames 21 have been cut to size in process step C. If, for example, cutting has been performed to the left halves 22, then in the stereoscopic video film 2 the monoscopic video film will be released with delay for the left eye 24 of the viewer 26 and the monoscopic video film for the right eye 25 of the viewer 26 will be released without delay.

The size of the amount of delay in frames per second depends, firstly, on the motion speed of the video recording device 4 in regard to the reference object, and, secondly, how strong the stereoscopic effect 12 of the stereoscopic video film 2 is to be. In this regard, the amount of the delay is to be selected the larger the higher the motion speed of the video recording device 4 is or the stronger the desired stereoscopic effect 12 is to be, respectively. Preferably, the adjusted delay in frames per second is between a third and two thirds of the recording rate of the video recording device 4, especially preferably the half of the recording rate of the video recording device 4.

The selection by which amount in frames per second the side that is to be presented with delay is to be released may also be made manually by the viewer 26.

The first processing 15, hence, advantageously uses a “lens effect”, this is the distorted display of the filmed object 11 as a function of its position on the projected monoscopic image area in regard to the central axis of the optical lens 9. Using this lens effect enables to overcome a well-established prejudice among experts, this is that there will be no motion parallax and thus no stereoscopic effect 12 if the video recording device 4 moves exclusively in the direction of the optical axis of the single objective 8 and the optical lens 9, this is along the first motion component 17.

According to the first processing 15, hence, even on the exclusive availability of the first motion component 17, there may be generated a motion parallax and thus a “genuine” stereoscopic video film 2 having a “genuine” stereoscopic effect 12. In this way, in the process step C, the distortion caused by the optical lens 9 of the respective recorded image 20 may be evaluated by the data processing unit 3 essentially in real time. By way of this evaluation, a motion parallax is then determined by the data processing unit 3, and after the process steps C and D have been performed, a stereoscopic video film 2 having a genuine stereoscopic effect 12 will be generated. “Genuine” in this case means, for example, that the data processing unit 3, a machine or a robot recognizes where an object 11 is located in the “space” of the stereoscopic video film 2, meaning whether it is located in front of or behind another object 11. A robot, for example, an autonomous and unmanned drone, may in this way autonomously head towards objects 11 or avoid these.

Similar systems or methods for producing a stereoscopic effect on exclusive availability of a motion direction of a video recording device comparable with the first motion component 17, for example as described in the document by Zhang, X. et al: “Visual video image generation . . . ”, IEICE Trans. Inf. & Syst., Bd. E83-D, No. 6, June 2000, pages 1266-1273,XP000976220, ISSN: 0916-8532, however, do not create a “genuine” stereoscopic effect 12, as only two shifted but identical images are released for the left eye and for the right eye of a viewer. In this way, only a “simulated” and “false” stereoscopic effect is produced, as it seems as if an object in the image for the left eye is at another location than in the image for the right eye. The image for the left eye and the image for the right eye, however, are identical images, and for this reason the method according to Zhang, X. et al does not provide any depth information. For this reason, e.g., a robot cannot recognize where an object is located in the space of a stereoscopic film.

If, during a sequence of at least two subsequently recorded images 20 of the motion information 14 allocated to the monoscopic video film 7, a portion of the second motion component 18 is available, then the data processing unit 3 will process the stereoscopic video film 2 according to the second processing 16. In this context, there is always performed the second processing 16, provided the portion of the second motion component 18 in the motion direction 27 of the video recording device 4 is not zero.

The second motion component 18 is schematically illustrated in FIG. 4. Therein, the video recording device 4 moves transversely to the direction of the surface normal 19 on the projected monoscopic image area, in which the filmed object 11 is situated, along a parallel 28, from the left to the right (or from the right to the left). This projected image area may be considered being in parallel to an image 20 recorded by the image sensor 10. Because of the relative motion of the video recording device 4 transversely to at least one filmed object 11, there is developed a motion-parallax. The motion parallax enables the presentation of the position of filmed objects 11 in space: firstly, filmed objects 11 move—as a function of their local distance to the optical lens 9—for the viewer 26 seemingly at different velocities, and, secondly, the viewer 26 sees these filmed objects 11—again as a function of their local distance to the optical lens 9—at different points of time and at different viewing angles.

If, during a continuous sequence of at least two successive frames 21, several filmed objects 11 move in the same or in different directions, the data processing unit 3 selects at least on reference object, by way of which the associated motion information 14 of the video recording device 4 is being determined. If, during a continuous sequence of at least two successive frames 21, the motion speed of at least one filmed object 11 changes, the motion speed of the video recording device 4 is adjusted appropriately in order to prevent double or blurred images of the stereoscopic film 2 to be released. The higher the motion speed of the film object 11 is, the higher the motion speed of the video recording device 4 has to be.

The frames 21 of the monoscopic video film 7 need not be cut into size in the second processing 16. The data processing unit 3 in process step C doubles all recorded frames 21. These two sequences of content-identical frames 21 are subsequently released side-by-side and delayed to each other, respectively for the left eye 24 and the right eye 25 of the viewer 26, forming the stereoscopic video film 2. The two monoscopic video films of the stereoscopic video film 2 to be released are then formed by the frames 21 of the recorded monoscopic video film 7.

In an advantageous variant of the system 1 according to the invention, also in the second processing 16 all frames are cut to the size of their left halves 22 or their right halves 23. In the case that the motion information 14 of the video recording device 4 determined during the monoscopic video film 7 also requires the second processing 16, it may be prevented that during the replay of the stereoscopic video film 2 the side proportions of the two monoscopic video films change respectively for the left eye 24 and for the right eye 25 of the viewer 26.

In the second processing 16, however, in contrast to the first processing 15, the delay of the monoscopic video film 7 for the left eye 24 or for the right eye 25 of the viewer 26 is determined by way of the relative motion direction 27 of the video recording device 4 to the reference object. If, for example, the video recording device 4 moves from the left to the right in regard to the reference object, then in the stereoscopic video film 2 the monoscopic video film for the left eye 24 of the viewer 26 will be released with delay and the monoscopic video film for the right eye 26 of the viewer 26 will be released without delay.

The size of the amount of the delay in frames per second also in the second processing 16 depends, firstly, on the motion speed of the video recording device 4 in regard to the reference object and, secondly, on how strong the stereoscopic effect 12 of the stereoscopic video film 2 is to be. In this regard, the amount of delay is to be selected the higher, the higher the motion speed of the video recording device 4 in regard to the reference object is or how strong the desired stereoscopic effect 12 is to be. Preferably, the adjusted delay in frames per second is between a third and two thirds of the recording rate of the video recording device 4, especially preferably the half of the recording rate of the video recording device 4.

The selection, whether the monoscopic video film is to be released with delay for the left eye 24 of the viewer 26 or whether the monoscopic video film for the right eye 25 of the viewer 26 is to be released with a delay of a determined amount in frames per second, may also be made manually by the viewer 26.

As last process step E, the stereoscopic video film 2 processed in the process steps A to D is released by the data processing unit 3 to the stereoscopic display unit 6. The stereoscopic display unit 6 is composed in the embodiment according to the invention of a screen of a TV set or computer, or of a projector, and 3D glasses, preferably virtual reality 3D glasses.

FIG. 6 shows a block diagram of the system 1 according to the invention for releasing the stereoscopic video film 2 according to a further embodiment of the invention. The system 1 comprises, in addition to the embodiment depicted in FIG. 1, an autonomous and unmanned transport means 29, preferably a drone. The transport means 29 serves for recording and for guiding the video recording device 4. In order for the monoscopic video film 7 recorded therewith not appearing “blurred”, the video recording device 4 is mounted on the transport means 29 via a 3-axis-stabilisator 30. The transport means 29 further has a GPS module 31 so that the motion information 14 allocated to the monoscopic video film 7 may be determined automatically. The image information 13 and the motion information to be allocated to the monoscopic video film 7 are stored on the non-volatile storage 5, preferably a memory card. The data processing unit 3 receives the data from the non-volatile storage 5 and evaluates the motion information 14 allocated to the monoscopic video film 7 therefrom. Consequently, the data processing unit 3 proceeds as described in the previous embodiment.

FIG. 7 shows a block diagram of the system 1 according to the invention, similar to the embodiment depicted in FIG. 6, wherein the transport means 29 has a data communication unit 32 instead of the non-volatile storage 5. The data communication unit 32 performs a wireless transfer of the image information 13 and the motion information 14 to be allocated to the monoscopic video film 7 to the data processing unit 3 having a corresponding receiver. Within the frame of the radio range of the data communication unit 32, the date are transferred to the data processing unit 3 essentially in real time. The data processing unit 3 receives the data and evaluates therefrom the motion information 14 allocated to the monoscopic video film 7. Consequently, the data processing unit 3 proceeds as described in the embodiment illustrated in FIG. 1.

FIG. 8 shows a block diagram of the system 1 according to the invention, similar to the embodiment depicted in FIG. 7, wherein a mobile telecommunication device 33, preferably a smart phone or a mobile tablet computer, comprises the data processing unit 3 and the screen of the stereoscopic display unit 6 in a housing 34. The data processing unit 3 of the mobile telecommunication device 33 receives the image information 13 and the motion information to be allocated to the monoscopic video film 7 from the data communication unit 32 of the transport means 29 and evaluates therefrom the motion information 14 allocated to the monoscopic video film 7. Subsequently, the data processing unit 3 proceeds as described in the embodiment depicted in FIG. 1. Using 3D glasses, the viewer 26 may view the stereoscopic video film 2 directly on the mobile data communication device 33.

In an advantageous variant of the system 1 according to the invention, the viewer 26 integrates the telecommunication device 33 directly into virtual reality 3D glasses. The viewer 26, in this way, may view the stereoscopic video film 2, which is processed by the data processing unit 3 from the monoscopic video film 7 recorded by the video recording device 4, essentially in real time by means of the system 1 depicted in FIG. 8.

In an advantageous variant of the embodiment of the system 1 illustrated in the FIGS. 6 to 8, the motion information 14 allocated to the monoscopic video film 7, which stores or transfers the transport means 28, is composed of the motion direction 27 of the video recording device 4 in regard to the filmed object 11 as well as of the motion speed and the recording rate of the video recording device 4. In this way, the data processing unit 3 may, after having received these data in process step A, automatically perform the process steps B to D so that in process step E there may be released an optimal stereoscopic video film 2 to the stereoscopic display unit 6.

FIG. 9 shows another advantageous embodiment of the invention. Therein, the system 1 serves for releasing a stereoscopic panoramic image 35. In this regard, the video recording device 4 is held in a stationary position by the viewer 26 or by the transport means 29, this is having constant coordinates in space, while the video recording device 4 records a monoscopic 360-degrees-video film 36. In the process, the video recording device 4 is rotated by full 360 degrees about its own axis 37, Its own axis 37, in this process, is essentially perpendicular to the earth surface, and the 360-degrees-rotation is performed essentially in parallel to the earth surface. In the present example the video recording device 4 is configured as a telecommunication device 33 or as a smart phone, respectively, which is guided by the viewer 26 with his arms extended. From the recorded monoscopic 360-degrees-video film 36, the data processing unit 3 processed two content-identical but delayed monoscopic 360-degrees-video films, which then form the stereoscopic panoramic image 35 side by side. The delayed release of the monoscopic 360-degrees-video film for the left eye 24, or for the right eye 25, respectively, of the viewer 26 is processed according to the second processing 16. If the viewer 26 moves the video recording device 4 from the left to the right, this is clock-wise, the monoscopic 360-degrees-video film 36 for the left eye 24 will be released with delay if the viewer 26 moves the video recording device 4 from the right to the left, this is counter-clockwise, the monoscopic 360-degrees-video film 36 for the right eye 25 will be released with delay. The stereoscopic panoramic image 35 may be viewed by the viewer 26 by means of the stereoscopic display unit 6, which in the present example is composed of the telecommunication device 33 and passive virtual reality 3D glasses 38, into which the smart phone is inserted as a display. In this context, the passive virtual reality 3D glasses 38 comprise a housing and two optical lenses, which direct the viewing direction of the left eye, or the viewing direction of the right eye, respectively, of the viewer to the monoscopic video film for the left eye 24, or for the right eye 25, respectively, of the viewer 26. If the viewer 26 moves his head, and thus the passive virtual reality 3D glasses 38, a gyroscope of the telecommunication device 33 will recognize this motion, and the data processing unit 3 will release the two monoscopic 360-degrees-video films of the stereoscopic panoramic image 35, corresponding to the motion direction and the motion speed of the virtual reality 3D glasses 38. The release rate corresponds exactly to the motion speed of the passive virtual reality 3D glasses 38. In this way, the two released monoscopic 360-degrees-video films appear as a stereoscopic panoramic image 35 for the viewer 26.

In an advantageous embodiment, the viewer 26 wears active virtual reality 3D glasses, which comprise the display and the gyroscope in a housing. In this way, the viewer 26 may view the stereoscopic panoramic image 35 also without a telecommunication device 33, if the active virtual reality 3D glasses receive the stereoscopic panoramic image 35 from the data processing unit 3 or if they comprise this data processing unit 3 in the housing.

In a further advantageous embodiment of the system 1, the video recording device 4 is configured as a 360-degrees-video recording device. Therein, the 360-degrees-video recording device comprises a single objective 8, which covers a recording area of 360 degrees in three-dimensional space, horizontally and vertically transversally to the optical axis of the single objective 8. This recording area corresponds to a spherical surface. Preferably, the 360-degrees-video recording device comprises several single objectives 8, each having an image sensor 10 of its own; especially preferably the 360-degrees-video recording device comprises at least four single objectives 8, each having an image sensor 10 of its own. The several single objectives 8 each cover a recording area of at least 360 degrees divided by the number of all single objectives 8 available horizontally and vertically transversally to the optical axis of the respective single objective 8. The video recording device 4 moves while the monoscopic video film 7, which is composed of the individual parts of the monoscopic video films recorded by the single objectives 8, is being recorded.

Because of the configuration of the video recording device 4 as a 360-degrees-video recording device, the 360-degrees-surrounding is advantageously recorded in a monoscopic video film 7, which may subsequently be released as a stereoscopic video film 2 to the stereoscopic display unit 6 essentially in real time. Compared to other known 360-degrees-systems, which record the 360-degrees-surrounding in several individual images, which are later on combined, such a combination of images is not necessary. In this way, the system 1 according to the invention enables a simplified and improved generation and release of the stereoscopic video film 2 and thus prevents the occurrence of “stitching errors”, this is errors in the transition of two combined images, which may occur with the 360-degrees-systems already known.

If, for example, there is present a configuration of the system 1 according to FIG. 6, wherein the video recording device 4 is configured as a 360-degrees-video recording device, the data processing unit 3 may, after having received the data in process step A, perform the process steps B to D in an automatized way such that in process step E a stereoscopic video film 2 may be released to the stereoscopic display unit 6. In the process steps B to D, the data processing unit 3 processes, by way of the monoscopic video films 7 and the motion information 14 allocated to the respective monoscopic video films 7 of all single objectives 8, the stereoscopic video films 2 to be released of all single objectives 8. In this way, there may be processed a smooth transition between the different recording areas of the single objectives 8 such that there is developed a complete virtual stereoscopic 360-degrees-surrounding in all spatial axes, this is a virtual stereoscopic space in the form of a sphere.

If the viewer 26 wears passive or active virtual reality 3D glasses and if he glances within the virtual 360-degrees-surrounding, the data processing unit 3, according to the motion of the viewer 26, selects the stereoscopic video film 3 corresponding to this motion of the single objective 8 associated with this viewing direction. In this way, the viewer 26 may glance in an essentially free way within a stereoscopic virtual surrounding. The viewer 26 then sees, while the stereoscopic video film 2 is being released, respectively the part of the virtual sphere surface, which corresponds to his viewing direction, or to the spatial direction of the passive or active virtual reality 3D glasses 38, respectively. The viewer 26 himself “adjusts his virtual motion” to the motion direction of the video recording device 4, while the monoscopic video film 7 is being recorded.

It may be noted that the system 1 according to the invention is also suited for releasing a stereoscopic image from the monoscopic video film 8. In this way, the stereoscopic image is composed of two images that are released side-by-side (a left one for the left eye 24 of the viewer 26 and a right one for the right eye 25 of the viewer 26). The stereoscopic image is herein generated by a so-called “screenshot” from the stereoscopic video film, meaning that a determined frame of the processed stereoscopic video film 2 is released to the stereoscopic display unit 6.

1. A system for releasing a stereoscopic video film, the system comprising:
a data processing unit configured to receive and process a monoscopic video film and to release the stereoscopic video film, wherein the monoscopic video film has been recorded using a video recording device of the system having only a single objective, wherein the data processing unit is configured to receive and evaluate a motion information allocated to the monoscopic video film or to determine the motion information to be allocated to the monoscopic video film and to evaluate the received or identified motion information characterizing a motion direction of the video recording device in regard to a filmed object, wherein the data processing unit is configured to generate a stereoscopic video film from two content-identical and temporally delayed monoscopic video films, wherein the data processing unit, on the availability of a first motion component of the video recording device in the direction of the optical axis of the single objective during a sequence of at least two successive frames, will select only the left half or only the right half of the frames of the monoscopic video film.

2. The system according to claim 1, further comprising,
a second motion component of the video recording device is determined transversely to the direction of the optical axis of the single objective, wherein the data processing unit, on the availability of exclusively the first motion component, is configured to process the stereoscopic video film according to a first processing and, on the availability of the second motion component during a sequence of at least two successive frames, to process the stereoscopic video film according to a second processing.

3. The system according to claim 2, wherein the data processing unit in the first processing will select only the left half or only the right half of the frames of the monoscopic video film for the presentation of two content-identical and temporally delayed monoscopic video films as a stereoscopic video film, wherein the data processing unit, when having selected the left half, or when having selected the right half, respectively, of the frames of the monoscopic video film, is configured to release with delay the monoscopic video film for the left eye, or for the right eye, respectively, of the viewer of the stereoscopic video film, and to release without delay the monoscopic video film for the right eye, or for the left eye, respectively, of the viewer of the stereoscopic video film.

4. The system according to claim 2, wherein the data processing unit in the second processing will select only the left half or only the right half of the frames of the monoscopic video film for the presentation of the two content-identical and temporally delayed monoscopic video films as a stereoscopic video film, wherein the data processing unit, on the availability of a second motion component corresponding to a relative motion of the video recording device towards the filmed object from the left to the right, or from the right to the left, respectively, is configured to release with delay the monoscopic video film for the left eye, or for the right eye, respectively, of the viewer of the stereoscopic video film, and to release without delay the monoscopic video film for the right eye, or for the left eye, respectively, of the viewer of the stereoscopic video film.

5. The system according to claim 1, wherein the data processing unit, on the availability of the first motion component of the video recording device in the direction of the optical axis of the single objective during a sequence of at least two successive frames, in the first processing and in the second processing will select a left-weighted partial image as the left half or a right-weighted partial image as the right half of the frames of the monoscopic video film.

6. The system according to claim 1, wherein the motion information allocated to the monoscopic video film characterizes a motion direction of the video recording device in regard to the filmed object, a motion speed of the video recording device and a recording rate of the video recording device.

7. The system according to claim 1, wherein the data processing unit is configured to generate the stereoscopic video film from two content-identical and temporally delayed monoscopic video films, wherein the selection of the delayed release for either the left eye or the right eye of the viewer as well as the amount of the temporal extent of this delayed release may be performed manually.

8. The system according to claim 1, wherein the system further comprises:
a 3-axis-stabilisator configured to stabilize the video recording device during the recording of the monoscopic video film.

9. The system according to claim 1, wherein the system further comprises:
a non-volatile storage configured to store the monoscopic video film recorded using the video recording device, or a data communication unit, which is configured to communicate the recorded monoscopic video film and the motion information allocated to the monoscopic video film in a wireless way.

10. The system according to claim 8, further comprising:
an autonomous, unmanned transport means, preferably a drone, for recording and for guiding the video recording device, wherein the autonomous, unmanned transport means has the 3-axis-stabilisator and a GPS module.

11. The system according to claim 1, wherein the system further comprises:
a stereoscopic display unit connected to the data processing unit and which is configured to display the stereoscopic video film, wherein the stereoscopic display unit is configured as a screen of a TV set or a computer, or as a projector, and has 3D glasses, preferably active or passive virtual reality 3D glasses.

12. The system according to claim 1, wherein the data processing unit is configured as a mobile telecommunication device such as, e.g., a smart phone, or as a mobile tablet computer, wherein the data processing unit is provided in a housing together with the screen of the stereoscopic display unit.

13. The system according to claim 11, wherein the video recording device is configured to record a monoscopic 360-degrees-video film in an stationary position by means of a full 360-degrees-rotation essentially in parallel to the earth surface about an axis perpendicular to the earth surface, wherein the data processing unit is configured to process a stereoscopic panoramic image from two content-identical and temporally delayed monoscopic 360-degrees-video films, wherein the release of the stereoscopic panoramic image is realized according to the motion direction and the motion speed of the 3D glasses of the viewer.

14. The system according to claim 1, wherein the video recording device is configured as a 360-degrees-video recording device, wherein the 360-degrees-video recording device has a single objective, which covers a recording area of 360 degrees transversely to the optical axis of the single objective.

15.-18. (canceled)
